(19) United States
(12) Patent Application Publication
(10) Pub. No.: US 2006/0020589 A1
(43) Pub. Date: Jan. 26, 2006

(54) System and method for searching for content stored by one or more media servers

(75) Inventors: Tao Wu, Woburn, MA (US); Sadhna Ahuja, Waltham, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/188,897

(22) Filed: Jul. 25, 2005

Related U.S. Application Data
(60) Provisional application No. 60/591,022, filed on Jul. 26, 2004.

(51) Int. Cl. G06F 17/30

(52) U.S. Cl. 707/3

(57) ABSTRACT

A system for searching for content includes at least one media server, a network entity and a content gateway. The media servers are capable of storing at least one piece of content. The network entity, then, is capable of sending a request identifying a piece of content stored by at least one of the media servers. The content gateway can receive the request and search the media servers across at least one network based upon the request. In this regard, the content gateway can search the media servers to identify a media server storing the identified piece of content. Thereafter, the content gateway is capable of responding to the request by identifying, to the network entity, the identified media server. The network entity can then download the piece of content from the identified media server, if so desired.

### CROSS-REFERENCE TO RELATED APPLICATIONS

The present application claims priority from U.S. Provisional Patent Application No. 60/591,022, entitled: System and Method for Searching for Content Stored by One or More Media Servers, filed on Jul. 26, 2004, the contents of which are incorporated herein by reference in its entirety.

### FIELD OF THE INVENTION

The present invention generally relates to systems and methods of searching at least one device for content stored by at least one of the devices and, more particularly, relates to systems and methods of a mobile terminal searching at least one media server for content stored by at least one of the media servers.

### BACKGROUND OF THE INVENTION

In the emerging digital home, consumers are acquiring, viewing and/or managing an increasing amount of digital content, particularly media content like photographs, music and video media. In this regard, consumers are increasingly acquiring, viewing and/or managing such content on devices in a number of different domains, including consumer electronics (CE), mobile device and personal computer (PC) device domains. And as will be appreciated, consumers often desire to conveniently enjoy such content across different devices and locations in their homes, regardless of the source. In many homes, digital content is stored by a number of different devices, referred to as media servers by the Digital Living Network Alliance (DLNA). These media servers include, for example, set-top boxes (STBs), personal video recorders (PVRs), PCs, stereo and home theaters that include non-volatile memory (e.g., music servers), broadcast tuners, video and imaging capture devices (e.g., cameras, camcorders, etc.), and/or multimedia mobile terminals (e.g., mobile telephones, portable digital assistants (PDAs), pagers, laptop computers, etc.).

In one of the more probable use cases for acquiring, viewing and/or managing digital content in the home, a user operates a mobile terminal to browse and search content stored by a number of different media servers. After locating the desired content, then, the user can acquire, view and/or manage such content from the media server storing the content. For example, the user can then choose to download the content to the user's mobile terminal, such as to take with the user on a trip. In the current architecture proposed by the DLNA, however, the user must search content on a per-media server basis. Thus, if the user does not know or remember where the desired content is stored (as is often the case), the user must search each media server, one by one, until the content is located.

Whereas searching for content on a per-media server basis is adequate to locating desired content, such an approach has several drawbacks. For example, searching for content on a per-media server basis can result in poor usability, poor reliability in discovery and poor efficiency of power consumption, one or more of which can increase as the number of media servers increase. In this regard, requiring the user to search each and every media server can be a very tedious and time consuming. For example, if there are N media servers, the user may need to perform the search operation N times every time the user searches for desired content.

Also, when a mobile terminal communicates with one or more media servers, such communication is typically by means of a wireless networking technique, such as a wireless local area networking (WLAN) or Bluetooth technique. Such wireless networking techniques, however, have frame corruption rates that are orders of magnitude greater than that of wired networking techniques, such as local area networking (LAN) techniques (e.g., Ethernet). Also, consider that the DLNA architecture provides for devices connected to a home network, including the mobile terminal and media servers, to utilize universal plug and play (UPnP) service discovery. However, UPNP utilizes the user datagram protocol (UDP) for service discovery, which is an unreliable protocol. In this regard, making service discovery requests and receiving responses over the unreliable wireless link on a per-media server basis may negatively affect performance as the probability of one of the request or response packets may increase with the number of media servers.

Further, keeping active network interfaces significantly increases the mobile terminal's power consumption. For example, maintaining active Bluetooth personal area network (PAN) connections can increase a mobile terminal's power consumption by 4.5 times (measured by current, increased from 13 mA to 72 mA). With many mobile terminals that also include a backlit display, the actual discovery application can further double the power consumption (to 160 mA) as the backlight of the display is typically illuminated during operation of the discovery application. Further, because searching multiple media servers typically requires more time than searching a single media server, it further increases the mobile terminal's power consumption.

### SUMMARY OF THE INVENTION

In light of the foregoing background, embodiments of the present invention provide an improved system, and associated network entity, content gateway and method for searching for content stored by one or more media servers. In accordance with embodiments of the present invention, a content gateway can search the media servers for one or more pieces of content on behalf of the network entity. In contrast to conventional search techniques, the content gateway can be capable of searching the media servers in a manner with reduced frame corruption rates. Also, the content gateway can be capable of searching the media servers in a manner that reduces the time required to locate the desired content, and without the undesirable power consumption that may otherwise be experienced by the terminal.

According to one aspect of the present invention, a system is provided for searching for content. The system includes at least one media server, a network entity (e.g., mobile terminal, media server, media player, etc.) and a content gateway. The media servers are capable of storing at least one piece of content. The network entity, then, is capable of sending a request identifying a piece of content stored by at least one of the media servers, where the request can be sent at least partially across a wireless link. The content gateway can receive the request and search the media servers across at least one network based upon the request and in parallel, if so desired. In this regard, the content gateway can be capable of searching at least one of the media servers across at least one wireline link. Additionally or alternatively, the content gateway can be capable of searching at least one of the media servers across at least one wireless link. Irrespective of how the content gateway searches the media servers, the content gateway can search the media servers to identify a media server storing the identified piece of content. Thereafter, the content gateway is capable of responding to the request by identifying, to the network entity, the identified media server. The network entity can then download the piece of content from the identified media server.

More particularly, the network entity can be capable of sending a request identifying a plurality of pieces of content. In such an instance, the content gateway can be capable of searching the media servers to identify at least one media server, each identified media server storing at least one of the pieces of content. Then, the content gateway can be capable of responding to the request by identifying, to the network entity, each of the identified media servers and the piece(s) of content stored by the respective media server. If so desired, the network entity can be capable of selecting, or receiving a selection of, at least one of the pieces of content stored by the identified media servers. The network entity can then be capable of downloading the selected piece(s) of content from the respective media servers.

According to other aspects of the present invention, a terminal, content gateway and method are provided for searching for content. Embodiments of the present invention therefore provide an improved system, and associated network entity, content gateway and method for searching for content. As indicated above, and explained below, the content gateway can be capable of searching one or more of the media servers via a wireline link in accordance with a wireline networking technique (e.g., LAN), which typically does not suffer from the frame corruption rates of wireless networking techniques (e.g., WLAN) otherwise utilized by the terminal in performing the same query. Also, the content gateway can search the media servers in parallel, thereby reducing the time required to locate desired content, as compared to conventional search techniques where the terminal searches for content on a per-media server basis. Further, as the content gateway can comprise a fixed device capable of utilizing a constant power source, the content gateway can search the media servers without the undesirable power consumption that may otherwise be experienced by the terminal in performing the same search. As such, the system and associated network entity, content gateway and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for searching for content stored by at least one device, in accordance with to one embodiment of the present invention;

FIG. 2 is a block diagram of an entity capable of operating as a terminal, a media server, media player and/or a content gateway, in accordance with embodiments of the present invention;

FIG. 3 is a schematic block diagram of a mobile terminal, in accordance with one embodiment of the present invention;

FIG. 4 is a functional block diagram of a network entity requesting, and thereafter downloading, one or more pieces of content stored by one or more media servers, in accordance with embodiments of the present invention; and

FIG. 5 is a flowchart illustrating various steps in a method of searching at least one media server for one or more piece(s) of content, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

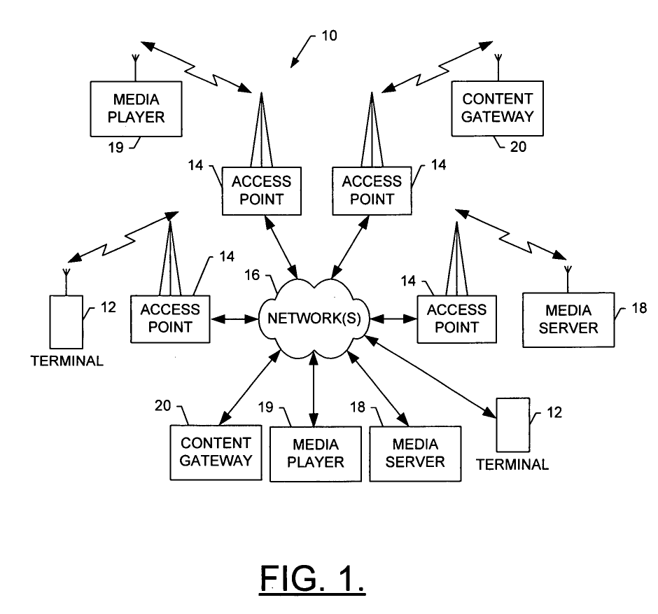

Reference is now made to FIG. 1, which illustrates a system 10 and a mobile terminal 12 for searching for content stored by at least one device. As shown, the terminal may include an antenna for transmitting signals to and for receiving signals from one or more wireless access points 14, one of which is illustrated in FIG. 1. The access point(s) are a part of one or more networks 16, one or more of which include elements capable of sending content to, and/or receiving content from, the terminal via the access point, as explained below. The network(s) can comprise one or more wireline and/or wireless networks, including one or more data and/or cellular networks. In this regard, the network(s) can include data networks, such as a personal area network (PAN), a local area network (LAN), a metropolitan area network (MAN), and/or a wide area network (WAN) like the Internet. In such instances, the access point(s) can be configured to communicate with the terminal in any of a number of different communication techniques supported by such networks. For example, the access point(s) can be configured to communicate with the terminal in accordance with radio frequency (RF), Bluetooth and/or wireless LAN (WLAN) techniques.

Additionally or alternatively, the network(s) 16 can include one or more cellular networks, such as any one or more of a number of first-generation (1G), second-generation (2G), 2.5G and/or third-generation (3G) cellular networks. For example, one or more of the network(s) can comprise 2G networks capable of supporting communication in accordance with wireless communication protocols such as IS-136 (TDMA), GSM, and IS-95 (CDMA). Also, for example, one or more of the network(s) can comprise 2.5G networks capable of supporting communication in accordance with wireless communication protocols General Packet Radio Service (GPRS), Enhanced Data GSM Environment (EDGE), or the like. Further, for example, one or more of the network(s) can comprise 3G networks capable of supporting communication in accordance with wireless communication protocols such as Universal Mobile Telephone System (UMTS) network employing Wideband Code Division Multiple Access (WCDMA) radio access technology. In such instances, the access point(s) 14 can be configured to communicate as base station(s) or base site(s), which are well known to those skilled in the art.

As shown and described herein, the network(s) 16 include a LAN, with an access point 14 configured to communicate in accordance with an RF, Bluetooth and/or WLAN technique. It should be understood, however, that the network(s) can comprise any of a number of other networks capable of supporting the transmission of data to and/or from a terminal 12. Likewise, it should be understood that the access point can be configured to communicate in accordance with any of a number of other techniques supported by the respective network(s), without departing from the spirit and scope of the present invention.

As also shown in FIG. 1, devices such as media servers 18 and/or media players 19 can be coupled to the network(s) 16, and thus the terminal 12 via the access point 14, although it should be understood that one or more such devices can be more directly coupled to the terminal without any switches or routers that may otherwise be included within the network(s). The media servers and/or media players can be coupled to the network(s) in any of a number of different manners. For example, one or more media servers and/or media players can be directly coupled to one or more of the networks. Additionally or alternatively, one or more of the media servers and/or media players can be indirectly coupled to one or more of the networks via an access point, the access point being the same as or different from the access point coupling the terminal to the network(s).

The media servers 18 can comprise any of a number of different devices capable of providing content acquisition, recording, storage and/or sourcing capabilities. For example, in accordance with the DLNA architecture, the media servers can comprise set-top boxes (STBs), personal video recorders (PVRs), PCs, stereo and home theaters that include non-volatile memory (e.g., music servers), broadcast tuners, video and imaging capture devices (e.g., cameras, camcorders, etc.), and/or multimedia mobile terminals (e.g., mobile telephones, portable digital assistants (PDAs), pagers, laptop computers, etc.). Irrespective of the specific device, each media server is capable of storing content capable of being downloaded by a terminal 12 via the network(s) and the access point 14. In this regard, the content can comprise any of a number of different types of content such as, for example, textual, audio, video and/or other types of multimedia content, software packages, applications, routines and/or other types of executable content.

The media players 19 can comprise any of a number of different devices capable of providing playback and/or rendering capabilities. In accordance with the DLNA architecture, for example, the media players can comprise television (TV) monitors, wireless monitors, game consoles, printers, PCs, stereo and home theaters, video and image capturing devices, and/or multimedia mobile terminals. As can be seen, in various instances, one or more devices may be capable of functioning as both a media server and a media player. More generally, one or more devices may be capable of functioning as more than one of a media server, a media player and a terminal 12, without departing from the spirit and scope of embodiments of the present invention.

As explained below and in accordance with embodiments of the present invention, the system 10 can further include a content gateway 20 coupled to the network(s), and thus the terminal 12, media servers 18 and media players 19. Generally, the content gateway can comprise any of a number of processors such as, for example, a personal computer, server computer, laptop computer or the like. Alternatively, the content gateway functionality can be incorporated into a device such as a set top box. The content gateway is capable of receiving a request from a network entity, such as a terminal, media server or media player, to search for one or more pieces of content stored by one or more of the media servers. In response to the request, the content gateway can search the media servers based upon the request. The content gateway can then receive a search result from each of the media servers indicating whether the respective media servers store the requested piece(s) of content. The search results can then be aggregated and sent or otherwise transmitted back to the network entity, which can thereafter download the requested piece(s) of content from those media servers storing the respective piece(s) of content.

Advantageously, and in contrast to conventional search techniques, the content gateway 20 can be capable of searching the media servers 18 on behalf of the network entity (e.g., terminal 12, media server, media player 19, etc.) via a wireline link in accordance with a wireline networking technique (e.g., LAN), which typically does not suffer from the frame corruption rates of wireless networking techniques otherwise utilized by the terminal in performing the same search. Also, the content gateway can, but need not, search the media servers in parallel, thereby reducing the time required to locate desired content, as compared to conventional search techniques where the network entity searches for content on a per-media server basis. Further, as the content gateway can comprise a fixed device capable of utilizing a constant power source, the content gateway can search the media servers without the undesirable power consumption that may otherwise be experienced by the network entity in performing the same search.

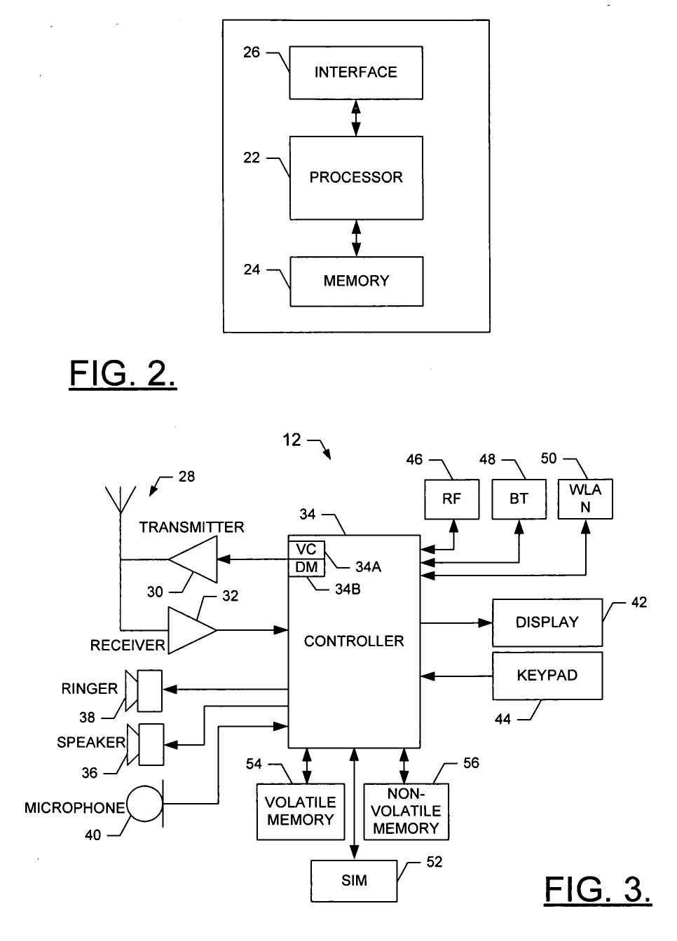

Referring now to FIG. 2, a block diagram of an entity capable of operating as a terminal 12, a media server 18, media player 19 and/or a content gateway 20, is shown in accordance with one embodiment of the present invention. Although shown as separate entities, in some embodiments, one or more entities may support one or more of a terminal, media server, media player and content gateway, logically separated but co-located within the entit(ies). For example, a single mobile terminal may not only support a mobile terminal but also support a logically separate, but co-located, media server, media player and/or content gateway. Also, for example, a single media server or media player may not only support a media server or media player, respectively, but also support a logically separate, but co-located content gateway, and/or media player or media server and content gateway, respectively.

The entity capable of operating as a terminal 12, a media server 18, media player 19 and/or a content gateway 20 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 22 connected to a memory 24. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention. In this regard, the memory can store a content manager capable of controlling the request and subsequent download of content stored by one or more media servers, as explained below. And when the entity comprises a content gateway, the memory can store a content agent capable of controlling the searching of the media servers.

The processor 22 can also be connected to at least one interface 26 or other means for transmitting and/or receiving data, content or the like. The interface(s) can include a means for communicating in accordance with any one or more of a number of different communication techniques. In this regard, the interface(s) can include means for communicating in accordance with any of a number of wireline and/or wireless communication techniques. For example, the interfaces can include an RF module, Bluetooth module and/or WLAN module capable of communicating in accordance with an RF, Bluetooth and/or WLAN communication technique, respectively. Additionally or alternatively, the interfaces can include means for communicating in accordance with 1 G, 2G, 2.5G and/or 3G communication techniques.

Reference is now drawn to FIG. 3, which illustrates a block diagram of a mobile terminal 12 in accordance with one embodiment of the present invention. The mobile terminal includes various means for performing one or more functions in accordance with exemplary embodiments of the present invention, including those more particularly shown and described herein. It should be understood, however, that the mobile terminal may include alternative means for performing one or more like functions, without departing from the spirit and scope of the present invention. More particularly, for example, as shown in FIG. 3, in addition to an antenna 28, the mobile terminal 12 can include a transmitter 30, receiver 32, and controller 34 or other processor that provides signals to and receives signals from the transmitter and receiver, respectively. These signals include signaling information in accordance with the air interface standard of the applicable cellular system, and also user speech and/or user generated data. In this regard, the mobile terminal can be capable of operating with one or more air interface standards, communication protocols, modulation types, and access types. More particularly, the mobile terminal can be capable of operating in accordance with any of a number of 1G, 2G, 2.5G and/or 3G communication techniques or the like.

It is understood that the controller 34 includes the circuitry required for implementing the audio and logic functions of the mobile terminal. For example, the controller may be comprised of a digital signal processor device, a microprocessor device, and various analog-to-digital converters, digital-to-analog converters, and/or other support circuits. The control and signal processing finctions of the mobile terminal are allocated between these devices according to their respective capabilities. The controller can additionally include an internal voice coder (VC) 34A, and may include an internal data modem (DM) 34B. Further, the controller may include the functionally to operate one or more software programs, which may be stored in memory (described below). For example, the controller may be capable of operating a connectivity program, such as a conventional Web browser. The connectivity program may then allow the mobile terminal to transmit and receive Web content, such as according to the Hypertext Transfer Protocol (HTTP) and/or the Wireless Application Protocol (WAP), for example.

The mobile terminal also comprises a user interface including a conventional earphone or speaker 36, a ringer 38, a microphone 40, a display 42, and a user input interface, all of which are coupled to the controller 34. The user input interface, which allows the mobile terminal to receive data, can comprise any of a number of devices allowing the mobile terminal to receive data, such as a keypad 44, a touch display (not shown) or other input device. In embodiments including a keypad, the keypad includes the conventional numeric (0-9) and related keys (#, *), and other keys used for operating the mobile terminal. Although not shown, the mobile terminal can include a battery, such as a vibrating battery pack, for powering the various circuits that are required to operate the mobile terminal, as well as optionally providing mechanical vibration as a detectable output.

As indicated above, the mobile terminal 12 can also include one or more means for sharing and/or obtaining data from access point(s) 14. As shown in FIG. 3, the mobile terminal can include a RF module 46 capable of transmitting and/or receiving content from one or more media servers 18 via the network(s) 16 and the access point. In addition or in the alternative, the mobile terminal can include other modules, such as, for example an, a Bluetooth (BT) module 48 and/or a WLAN module 50 capable of transmitting and/or receiving data in accordance with Bluetooth and/or WLAN techniques, respectively.

The mobile terminal 12 can further include memory, such as a subscriber identity module (SIM) 52, a removable user identity module (R-UIM) or the like, which typically stores information elements related to a mobile subscriber. In addition to the SIM, the mobile terminal can include other removable and/or fixed memory. In this regard, the mobile terminal can include volatile memory 54, such as volatile random access memory (RAM) including a cache area for the temporary storage of data. The mobile terminal can also include other non-volatile memory 56, which can be embedded and/or may be removable. The non-volatile memory can additionally or alternatively comprise an EEPROM, flash memory or the like. The memories can store any of a number of pieces of information, and data, used by the mobile terminal to implement the finctions of the mobile terminal. The memories can also store one or more applications capable of operating on the mobile terminal. As explained below, the memories can further store a content manager capable of controlling the request and subsequent download of content stored by one or more media servers 18.

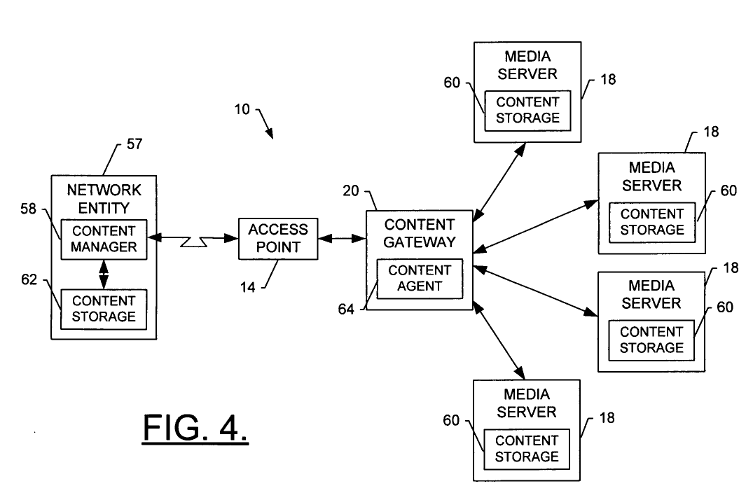

Reference is now drawn to FIG. 4, which illustrates a functional block diagram of a network entity 57 (e.g., terminal 12, media server 18, media player 19, etc.) requesting, and thereafter downloading, one or more pieces of content stored by one or more media servers. In accordance with embodiments of the present invention, the content gateway 20 searches the media servers on behalf of the network entity to identify those media servers storing the requested piece(s) of content such that the network entity can thereafter download the piece(s) of content from those media servers. As indicated above, the network entity can operate a content manager 58 capable of controlling the request and subsequent download of content stored by one or more media servers, such as in a content storage 60 (e.g., memory 38) of the media servers. After downloading the content, then, the content manager can store the requested content in a content storage 62 (e.g., non-volatile memory 56) of the network entity.

As also indicated above, the content gateway 20 can operate a content agent 64 capable of controlling the searching of the media servers based upon the request from the network entity 57. Thus, in accordance with embodiments of the present invention, the content manager 58 of the network entity can send a request for the content agent of the content gateway to search for one or more pieces of content stored in content storage 60 of one or more media servers 18. In response to receiving the request, the content agent can search the media servers to identify one or more media servers storing the requested piece(s) of content in respective content storage. The content agent can then send a response to the network entity identifying the media server(s) storing the requested piece(s) of content such that the network entity can thereafter download the requested piece(s) of content from the respective media server(s).

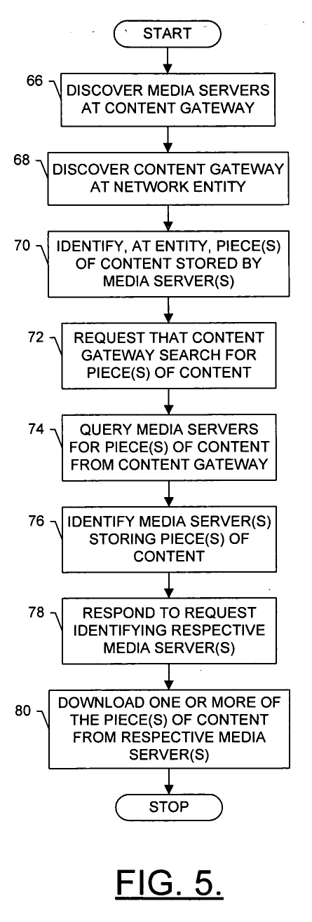

Reference is now made to FIG. 5, which illustrates various steps in a method of searching at least one media servers 18 for one or more piece(s) of content, in accordance with one embodiment of the present invention. As shown, the method can include the content gateway 20, or more particularly the content agent 64 of the content gateway, discovering at least one media server 18 coupled to the network(s) 16, as shown in block 66. The content agent can discover the media servers in any of a number of different manners. In accordance with UPnP, for example, the content agent can discover the media servers based upon service advertisements broadcast by the media servers onto the network(s), the service advertisements identifying the media servers to the content agent. Alternatively, the content agent can discover one or more of the media servers based upon a service discovery request broadcast by the content agent onto the network(s), to which the media servers can respond by identifying themselves to the content agent.

The method can also include the network entity 57 (e.g., terminal 12, media server 18, media player 19, etc.), or more particularly the content manager 58 of the network entity, discovering the content gateway 20 coupled to the network(s) 16, as shown in block 68. Like with the content agent 64, the content manager can discover the content gateway in any of a number of different manners. For example, in accordance with UPnP, the content manager can discover the content gateway based upon a service advertisement broadcast by the content gateway onto the network(s), the service advertisements identifying the content gateway to the content manager. Alternatively, the content manager can discover the content gateway based upon a service discovery request broadcast by the content manager onto the network(s), to which the content gateway can respond by identifying itself to the content manager.

Before, after or as the content gateway 20 discovers the media servers 18, and the network entity 57 discovers the content gateway, the content manager 58 of the network entity can identify, or receive an identification of, one or more pieces of content, as shown in block 70. The piece(s) of content can be identified in any of a number of different manners such as, for example, from a user interface of the network entity. For example, one or more of the piece(s) of content can be identified based upon one or more characteristics associated with the respective pieces of content. In this regard, one or more of the piece(s) of content can be identified by a name, type (e.g., audio, video, multimedia, etc.), size, and/or date of creation and/or modification associated with the respective piece(s) of content.

After the network entity 57 has discovered the content gateway 20 and one or more pieces of content have been identified, the network entity, or more particularly the content manager 58 of the network entity, can request that the content gateway, or more particularly the content agent 64 of the content gateway, search the media servers 18 for the identified piece(s) of content, as shown in block 72. For example, the content manager can send a request to the content agent identifying the respective piece(s) of content, where the request solicits the media server(s) storing the respective piece(s) of content. The request, then, can be received by the content agent of the content gateway via the access point 14 and the network(s) 16. As indicated above, by requesting that the content gateway search for the media server(s) storing the identified piece(s) of content, the content gateway can thereafter search one or more of the media servers across the network(s) in accordance with a wireline networking technique, which typically does not suffer from the frame corruption rates of wireless networking techniques otherwise utilized by the terminal.

In response to receiving the request, and after the content gateway 20 discovers the media servers 18, the content agent 64 of the content gateway can search the media servers 18 for one or more of those media servers storing the identified piece(s) of content in content storage 60. More particularly, for example, the content agent can send a query across the network(s) 16 to the media servers, the query identifying the respective piece(s) of content, as shown in block 74. As also indicated above, the content gateway can advantageously search, and thus send a query, to the media servers in parallel, if so desired. In this regard, by searching the media servers in parallel, the content gateway can reduce the time required to locate desired content, as compared to conventional search techniques where the terminal typically searches for content on a per-media server basis.

In response to receiving the query, the media servers 18 can determine if their respective content storage 60 includes one or more of the identified piece(s) of content. Each media server can then return a response to the content agent 64 of the content gateway 20 indicating whether the content storage of the media server includes one or more of the respective piece(s) of content, identifying the piece(s) of content stored by the media server. Alternatively, only those media servers having content storage that includes one or more of the identified piece(s) of content can return a response to the content agent.

By searching the media servers 18, the content agent 64 of the content gateway 20 can identify one or more media servers storing one or more of the piece(s) of content, as shown in block 76. Thereafter, the content agent can send a response to the request previously received from the content manager 58 of the network entity 57, such as back across the network(s) 16 and the access point 14, as shown in block 78. In this regard, the response can identify one or more of the media servers and the piece(s) of the identified piece(s) of content stored by the respective media server(s). Before sending the response, however, the content agent can process the response in one or more of a number of different manners. For example, the content agent can process the response to remove duplicate results. Thus, if more than one media server is identified as storing the same piece of content, the content agent can remove the association of that piece of content with all but one of the respective media servers. In such an instance, the content agent can select the media server to associate with that piece of content in any of a number of different manners. For example, the content agent can select, from the media servers storing that piece of content, the media server also associated with the greatest number of other identified piece(s) of content. Additionally or alternatively, the content agent can select, from the media servers storing that piece of content, the media server being capable of transferring that piece of content with the highest transfer rate, such as to the network entity.

Irrespective of whether the content agent 64 of the content gateway 20 processes the response, the content manager 58 of the network entity 57 can thereafter receive the response. At one or more instances after receiving the response, the content manager can select, or receive a selection of, one or more of the piece(s) of content identified in the response (along with associated media server(s) 18 storing the piece(s) of content). For example, the content manager can present the piece(s) of content on a user interface (e.g., display 42) of the network entity, as well as the media server(s) storing the piece(s) of content if so desired. The content manager can then receive, from a network entity user, a selection of one or more of the presented piece(s) of content.

After selecting, or receiving a selection of, one or more of the piece(s) of content, the content manager 58 of the network entity 57 can download the selected piece(s) of content from the respective media server(s) 18 storing the pieces of content, as shown in block 80. In this regard, the content manager can download the selected piece(s) of content by communicating with the respective media server(s) via the access point 14 and the network(s) 16 such that the respective media server(s) transmit the piece(s) of content from content storage 60 back to the content manager. Then, after receiving the selected piece(s) of content, the content manager can store the piece(s) of content in content storage 62 of the network entity. Additionally or alternatively, the content manager can direct the network entity, or more particularly a user interface (e.g., speaker 36, display 42, etc.) of the network entity, to present one or more of the piece(s) of content.

According to one aspect of the present invention, the functions performed by one or more of the entities of the system 10, such as the terminal 12, media server 18, media player 19 and/or content gateway 20, may be performed by various means, such as hardware and/or firmware, including those described above, alone and/or under control of a computer program product (e.g., content manager 58, content agent 64, etc.). The computer program product for performing one or more functions of embodiments of the present invention includes a computer-readable storage medium, such as the non-volatile storage medium, and software including computer-readable program code portions, such as a series of computer instructions, embodied in the computer-readable storage medium.

In this regard, FIG. 5 is a flowchart of methods, systems and program products according to the invention. It will be understood that each block or step of the flowchart, and combinations of blocks in the flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the flowchart. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowchart. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowchart.

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for searching for content, the system comprising:
at least one media server capable of storing at least one piece of content;
a network entity capable of sending a request identifying a piece of content stored by at least one of the media servers; and
a content gateway capable of receiving the request from the network entity and searching the media servers across at least one network based upon the request, the content gateway searching the media servers to identify a media server storing the identified piece of content, wherein the content gateway is capable of responding to the request by identifying, to the network entity, the identified media server such that the network entity is thereafter capable of downloading the piece of content from the identified media server.

2. A system according to claim 1, wherein the network entity is capable of sending the request to the content gateway at least partially across a wireless link, and
wherein the content gateway is capable of searching at least one of the media servers across at least one wireline link.

3. A system according to claim 2, wherein the content gateway is capable of searching at least one of the media servers across at least one wireless link.

4. A system according to claim 1, wherein the network entity is capable of sending a request identifying a plurality of pieces of content,
wherein the content gateway is capable of searching the media servers to identify at least one media server, each identified media server storing at least one of the pieces of content, and wherein the content gateway is capable of responding to the request by identifying, to the network entity, each of the identified media servers and the at least one piece of content stored by the respective media server.

5. A system according to claim 4, wherein the network entity is capable of one of selecting and receiving a selection of at least one of the pieces of content stored by the identified media servers, and thereafter downloading the selected at least one piece of content from the respective media servers.

6. A system according to claim 1, wherein the content gateway is capable of searching the media servers across at least one network in parallel.

7. A network entity comprising:
a controller capable of operating a content manager, wherein the content manager is capable of sending a request to a content gateway, the request identifying a piece of content stored by at least one media server,
wherein the content manager is capable of sending the request such that the content gateway receives the request, searches the media servers across at least one network based upon the request, identifies a media server storing the identified piece of content based upon the search, and responds to the request by identifying, to the content manager, the identified media server, and
wherein the content manager is capable of downloading the piece of content from the identified media server.

8. A network entity according to claim 7, wherein the content manager is capable of sending the request to the content gateway at least partially across a wireless link, and
wherein the content manager is capable of sending the request such that the content gateway searches at least one of the media servers across at least one wireline link.

9. A network entity according to claim 8, wherein the content manager is capable of sending the request such that the content gateway searches at least one of the media servers across at least one wireless link.

10. A network entity according to claim 7, wherein the content manager is capable of sending a request identifying a plurality of pieces of content,
wherein the content manager is capable of sending the request such that the content gateway identifies at least one media server, each identified media server storing at least one of the pieces of content, and such that the content manager identifies each of the identified media servers and the at least one piece of content stored by the respective media server.

11. A network entity according to claim 10, wherein the content manager is capable of one of selecting and receiving a selection of at least one of the pieces of content stored by the identified media servers, and thereafter downloading the selected at least one piece of content from the respective media servers.

12. A network entity according to claim 7, wherein the content manager is capable of sending the request such that the content gateway searches the media servers across at least one network in parallel.

13. A content gateway for searching for content, the content gateway comprising:
a processor capable of operating a content agent, wherein the content agent is capable of receiving a request from a network entity, the request identifying a piece of content,
wherein the content agent is capable of searching at least one media server across at least one network based upon the request,
wherein the content agent is capable of identifying a media server storing the identified piece of content based upon the search, and
wherein the content agent is capable of responding to the request by identifying, to the network entity, the identified media server such that the terminal can thereafter download the piece of content from the identified media server.

14. A content gateway according to claim 13, wherein the content agent is capable of receiving the request at least partially across a wireless link, and
wherein the content agent is capable of searching at least one of the media servers across at least one wireline link.

15. A content gateway according to claim 14, wherein the content agent is capable of searching at least one of the media servers across at least one wireless link.

16. A content gateway according to claim 13, wherein the content agent is capable of receiving a request identifying a plurality of pieces of content,
wherein the content agent is capable of identifying at least one media server, each identified media server storing at least one of the pieces of content, and
wherein the content agent is capable of responding to the request by identifying, to the network entity, each of the identified media servers and the at least one piece of content stored by the respective media server.

17. A content gateway according to claim 16, wherein the content agent is capable of responding to the request such that the terminal can thereafter download at least one of the pieces of content stored by the identified media servers.

18. A content gateway according to claim 13, wherein the content agent is capable of searching the at least one media server in parallel.

19. A method of searching for content, the method comprising:
receiving a request from a network entity, the request identifying a piece of content;
searching at least one media server across at least one network based upon the request;
identifying a media server storing the identified piece of content based upon the search; and
responding to the request by identifying, to the network entity, the identified media server such that the terminal can thereafter download the piece of content from the identified media server.

20. A method according to claim 19, wherein receiving a request comprises receiving a request at least partially across a wireless link, and
wherein searching at least one media server comprises searching at least one of the media servers across at least one wireline link.

21. A method according to claim 20, wherein searching at least one media server comprises searching at least one of the media servers across at least one wireless link.

22. A method according to claim 19, wherein receiving a request comprises receiving a request identifying a plurality of pieces of content,
wherein identifying a media server comprises identifying at least one media server, each identified media server storing at least one of the pieces of content, and
wherein responding to the request comprises responding to the request by identifying, to the network entity, each of the identified media servers and the at least one piece of content stored by the respective media server.

23. A method according to claim 22, wherein responding to the request comprises responding to the request such that the terminal can thereafter download at least one of the pieces of content stored by the identified media servers.

24. A method according to claim 19, wherein searching at least one media server comprises searching at least one media server across at least one network in parallel.
